(19) United States
(12) Patent Application Publication
(10) Pub. No.: US 2015/0032598 A1
(43) Pub. Date: Jan. 29, 2015

(54) SYSTEM AND METHOD FOR GENERATING A NATURAL HAZARD CREDIT MODEL

(71) Applicant: Corelogic Solutions, LLC, Irvine, CA (US)

(72) Inventors: Mark M. FLEMING, Falls Church, VA (US); Kathryn DOBBYN, Alexandria, VA (US)

(21) Appl. No.: 14/341,160

(22) Filed: Jul. 25, 2014

Related U.S. Application Data
(60) Provisional application No. 61/858,788, filed on Jul. 26, 2013.

(51) Int. Cl. G06Q 40/02

(52) U.S. Cl. CPC G06Q 40/025
USPC 705/38

(57) ABSTRACT

Embodiments include systems and methods of detecting and assessing multiple types of risks related to mortgage lending. One embodiment includes a system and method of detecting and assessing risks including early payment default risks, and natural hazards risks on loan applications. One embodiment includes a computerized method that includes creating a combined risk detection model based on a default and natural hazards risk detection models and using the combined risk detection model to evaluate loan application data and generate a combined risk score that takes into account the different types of risks individually and collectively detected by the plurality of risk detection models.

### CROSS-REFERENCE TO RELATED APPLICATIONS

The present application contains subject matter related to that disclosed in U.S. Pat. Nos. 7,966,256 and 8,489,499 and U.S. patent application Ser. No. 13/238,059, the entire contents of which are hereby incorporated herein by reference in their entirety. The present application also claims the benefit of the earlier filing date of commonly owned U.S. Provisional Patent Application 61/858,788 filed on Jul. 26, 2013, the entire contents of which are hereby incorporated by reference in its entirety.

### BACKGROUND

1. Field

The present disclosure relates to computer processes for detecting and assessing multiple types of risks, and more specifically to natural hazard risks in financial transactions.

2. Description of the Related Art

Many financial transactions are fraught with risks. For example, a mortgage lender may face risks of borrower default. A default detection system may be configured to analyze loan application data to address the risk of borrower default.

However, existing risk detection systems have failed to keep pace with the dynamic nature of financial transactions. Moreover, such systems have failed to take advantage of the increased capabilities of computer systems.

### BRIEF DESCRIPTION OF THE DRAWINGS

Throughout the drawings, reference numbers may be re-used to indicate correspondence between referenced elements. The drawings are provided to illustrate example embodiments described herein and are not intended to limit the scope of the disclosure.

FIG. 1 is a block diagram that schematically illustrates an example of a system to generate a natural hazards credit model.

FIG. 2 is a schematic diagram illustrating an aspect of a combined natural hazards credit scoring model that provides an overall risk picture of a mortgage lending transaction.

FIG. 3 is a flowchart illustrating the operation of the risk detection and assessment system in accordance with an embodiment.

FIG. 4 is a flowchart illustrating a method of building a combined natural hazards credit model for detecting and assessing risks in financial transactions in accordance with an embodiment.

FIG. 5 is a flowchart illustrating an embodiment of a method of providing a score indicative of risks using the combined natural hazards credit model.

FIG. 6 is a flowchart illustrating a method of generating a combined natural hazards credit score in accordance with an embodiment.

FIG. 7 is a flowchart illustrating a method of adjusting a financial characteristic based on a generated combined natural hazards credit model in accordance with an embodiment.

FIG. 8 is a block diagram that schematically illustrates an example of one or more modules that may be included in a system to generate a natural hazards credit model.

FIG. 9 is a flowchart illustrating a method of identifying the impact of natural hazards in risk detection in accordance with an embodiment.

FIG. 10 is a flowchart illustrating another method of generating a combined natural hazards credit score in accordance with an embodiment.

### DETAILED DESCRIPTION

Various aspects of the disclosure will now be described with regard to certain examples and embodiments, which are intended to illustrate but not to limit the disclosure

Embodiments disclosed herein provide systems and methods for detecting and assessing various types of risks associated with financial transactions, such as transactions involved in mortgage lending. Embodiments of the risk detection and assessment system combine default risk and natural hazard risk models that are configured to detect and assess particular types of risks into a single combined model that is better suited for detecting risks in the overall transactions. Various embodiments disclosed herein combine discrete data models, each of which may be utilized on its own to provide a specific risk score.

Although the individual models may be capable of predicting individual risks, they may only offer a partial picture of the overall risks. From a risk management standpoint, a user of such predictive models would typically stand to suffer financial losses in mortgage transactions if any of such risks materialize. While it is theoretically possible to apply many or all of these individual models for every loan application, and generate scores from all the models and review them; in practice this becomes burdensome on the human reviewers. Indeed, by definition, a score is an abstraction of the risks, and the very nature of a risk score is to enable quick detection and assessment of risks without a human review of all the underlying data.

Therefore, in one embodiment, the combined model takes as input selected scores output by the default and natural hazard risk models and potentially other data, processes the selected scores and other data, and generates a single combined score that may reflect an overall risk of a particular transaction. The combined model presents these risks in a comprehensive fashion and is configured to detect potentially hidden natural hazard risks that may otherwise be difficult to detect by an individual model. The combined score may, in some embodiments, be used to adjust financial characteristics associated with the mortgage loans and/or make comparisons to the scores output by the individual models.

In one embodiment, such a combined model may be created based on evaluating the performance of the underlying models (or sets of models) in detecting risks, including natural hazard and default risks. One or more combined models may be based on data including, test/training data, current data, real-time data, a mix of historical data, current data, and/or real-time data. The performance of the resulting combined model may be evaluated against the performance of the individual models, and adjustments to the combined model may be made to further improve performance.

Implementations of the disclosed systems and methods will be described in the context of determining and/or predicting risks for real estate properties. This is for purposes of illustration and is not a limitation. For example, implementations of the disclosed systems and methods can be used to determine and/or predict risks for commercial property developments such as office complexes, industrial or warehouse complexes, retail and shopping centers, and apartment rental complexes. In addition, the term “mortgage” may include residential, commercial, or industrial mortgages. Further, “mortgage” may include first, second, home equity, or any other loan associated with a real property. In addition, it is to be recognized that other embodiments may also include risk detection in other types of loans or financial transactions such as credit card lending and auto loan lending.

### Example Risk Detection System

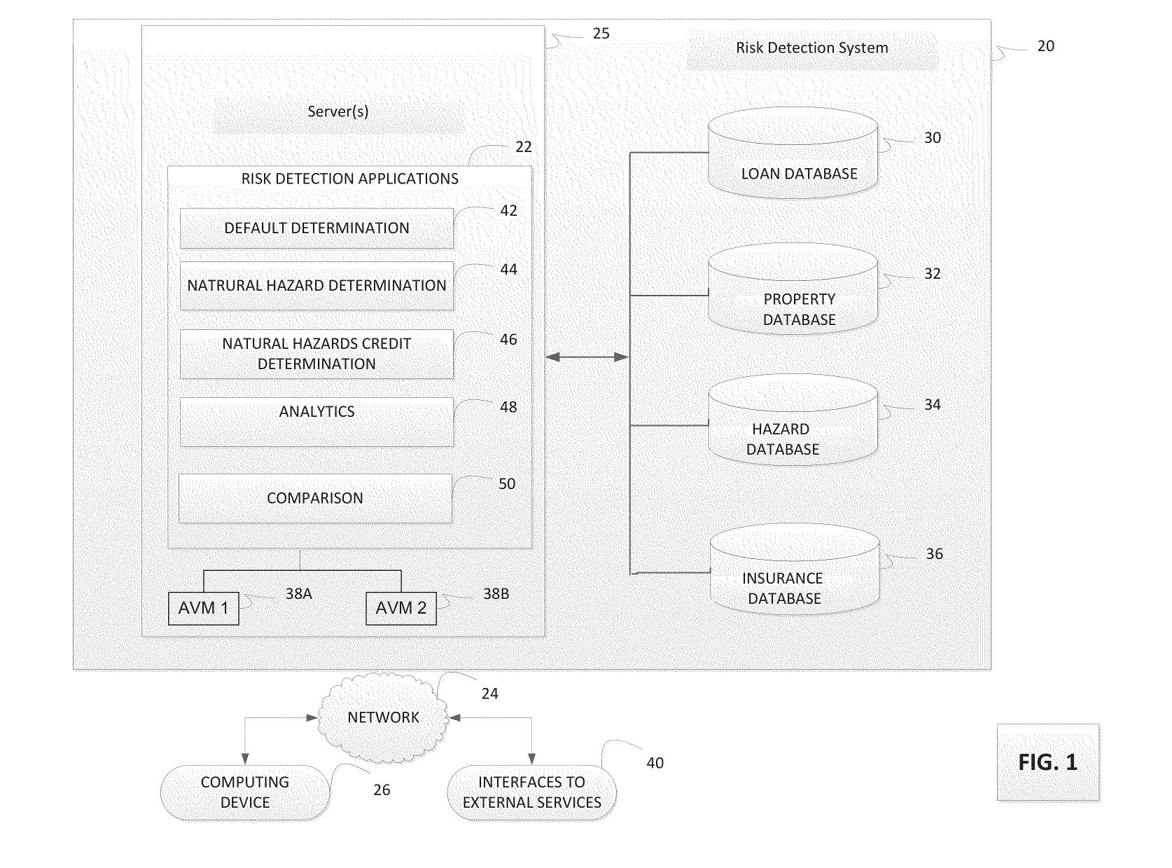

FIG. 1 illustrates a risk detection system 20 according to one embodiment. The system may be provided by a business entity or “risk detection provider” that provides various services to its customers for managing financial transactions associated with properties. As illustrated, the risk detection system 20 includes a set of risk detection applications 22 that are accessible over a network 24 (such as the Internet) via a computing device 26 (desktop computers, mobile phones, servers, etc.). Typical customers of the risk detection system 20 include mortgage lenders, other types of lenders, mortgage servicers, real estate investors, and property insurance companies.

As illustrated, risk detection applications 22 use a set of data repositories 30-36 to perform various types of financial risk management tasks, including tasks associated with risk detection. In the illustrated embodiment, these data repositories 30-36 include a database of loan data, loan database 30, a database of property data, property database 32, a database of hazard data, hazard database 34, and a database of insurance data, insurance database 36. Although depicted as separate databases, some of these data repositories 30-36 may be merged into a single database or distributed across multiple distinct databases. Further, additional databases containing other types of information may be maintained and used by the risk detection applications 22. As shown in FIG. 1, each risk detection application 22 runs on one or more physical servers 25 or other computing devices.

The database of loan data 30 preferably includes aggregated mortgage loan data collected by lenders from mortgage loan applications of borrowers. The risk detection system 20 may obtain the loan application in various ways. For example, lenders and other users of the risk detection system 20 may supply such data to the risk detection system 20 in the course of using the risk detection applications 22. The users may supply such data according to an agreement under which the risk detection system 20 can persistently store the data and re-use it for generating summarized analytics to provide to the same and/or other users. Such a database is maintained by CoreLogic, Inc. As another example, the risk detection system 20 may obtain such loan data through partnership agreements. As yet another example, the risk detection system 20 may itself be a mortgage lender, in which case the loan data may include data regarding its own loans. Loan data obtained by the risk detection system 20 from lenders is referred to herein as “contributed loan data.”

The property database 32 contains property data obtained from one or more of the entities that include property data associated with real estate properties. This data may include the type of property (single family home, condo, etc.), the sale price, and some characteristics that describe the property (beds, baths, square feet, etc.). These types of data sources can be found online. For example, multiple listing services (MLS) contain data intended for realtors, and can be contacted and queried through a network such as the Internet. Such data may then be downloaded for use by embodiments of the present invention. Other examples include retrieving data from databases/websites such as RedFin, Zillow, etc. that allow users to directly post about available properties. Furthermore, property database 32 may contain aggregated data collected from public records offices in various counties throughout the United States. This property database 32 can include property ownership information and sales transaction histories with buyer and seller names, obtained from recorded land records (grant deeds, trust deeds, mortgages, other liens, etc.). In one embodiment, the risk detection system 20 maintains the property database 32 by purchasing or otherwise obtaining public record documents from most or all of the counties in the United States (from the respective public recorders offices), and by converting those documents (or data obtained from such documents) to a standard format. Such a database is maintained by CoreLogic, Inc. The property database 32 is preferably updated on a daily or near-daily basis so that it closely reflects the current ownership statuses of properties throughout the United States. In one implementation, the property database 32 covers 97% of the sales transactions from over 2,535 counties.

The database of hazard data 34 contains natural hazard data obtained from one or more entities, such as CoreLogic, ParcelQuest, RedFin, government agencies, etc., that include data related to natural hazards, such as earthquakes, hurricanes, wildfires, floods and various severe weather events, associated with real estate properties. The natural hazard data may include historical natural hazards data associated with real estate properties and natural hazards risk data associated with real estate properties. Such a database is maintained by CoreLogic, Inc., which provides risks for individual hazards that are measured by individual scores grounded on science, observations, data, and models of reality. The score for each hazard peril reflects the intensity and frequency of individual hazards. Because of various characteristics of those hazards and various scientific measurements used in hazard risk methodologies, those derived scores could be in different scales, ranges and formats. Commonly owned U.S. patent application Ser. No. 13/238,059, contents of which are incorporated herein by reference in its entirety, describe the process to determine natural, including composite, hazard risks.

The insurance database 36 contains insurance data obtained from one or more of the entities that include insurance data associated with real estate properties. Insurance data can include insurance policies, insurance claims, insurance payment data, insurance fraud data, etc. These types of data sources can be found online. For example, insurance companies may contain such data and can be contacted and queried through a network such as the Internet. Such data may then be downloaded for use by embodiments of the present invention. In one embodiment, the risk detection system 20 maintains the insurance database 36 by purchasing or otherwise obtaining insurance documents from most or all of the insurance companies in the United States (from the respective offices), and by converting those documents (or data obtained from such documents) to a standard format.

As further shown in FIG. 1, the risk detection system 20 may also include one or interfaces 40 to other (externally hosted) services and databases. For example, the risk detection system 20 may include APIs or other interfaces for retrieving data from LexisNexis, RedFin, USGS, particular real estate companies, government agencies, and other types of entities.

As further shown in FIG. 1, the risk detection applications 22 include a “default determination” application or application component 42 (hereinafter “application 42”). As explained below, this application 42 uses some or all of the data sources described above to determine default risks associated with real estate properties.

The risk detection applications 22 also include a “natural hazards determination” application or application component 44 (hereinafter “application 44”). As explained below, this application 44 uses some or all of the data sources described above to determine natural hazard risks associated with real estate properties.

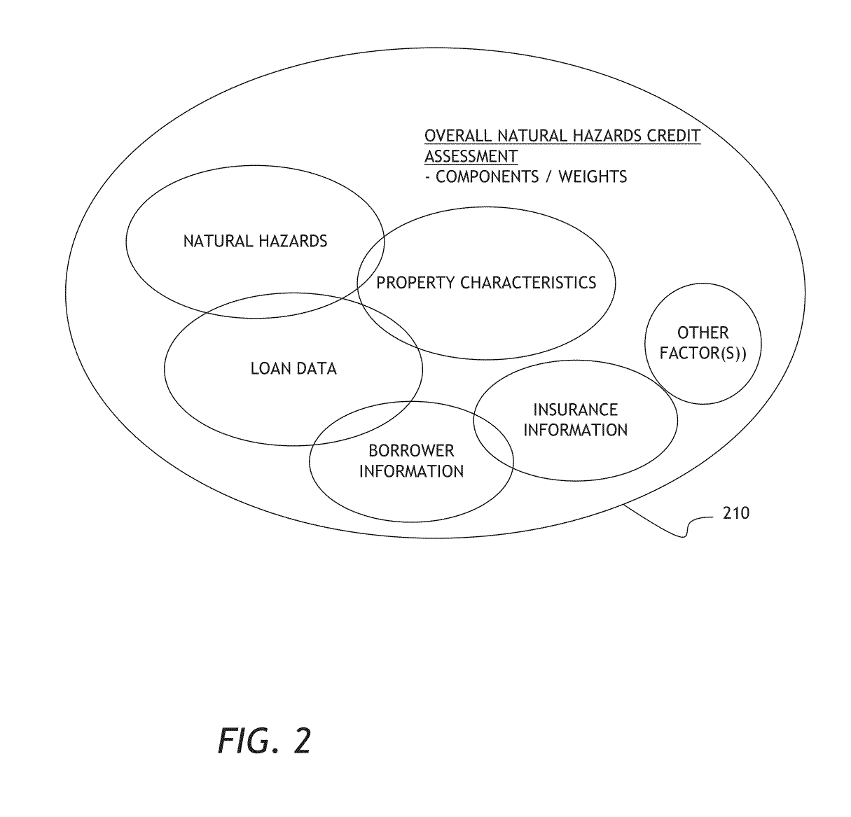

The risk detection applications 22 also include a “natural hazards credit determination” application or application component 46 (hereinafter “application 46”). As explained below, this application 46 communicates with applications 42 or 44, to determine natural hazards credit risks associated with real estate properties. As illustrated in FIG. 2, an overall natural hazards credit assessment 210 can based on a variety of factors, including natural hazards risks, property characteristics, loan data, borrower information, insurance information, etc. Each of these factors will be further explained below.

The risk detection applications 22 further include an “analytics” application or application component 48 (hereinafter “application 48”). As explained below application 48 can communicate with applications 42, 44, or 46, to perform one or more analytics based on determined natural hazards credit risks. For example, application 48 can communicate with AVM1 38A or AVM2 38B to determine an automated valuation for a particular property based on outputs from application 46. The analytics for a property of group of properties may be determined in response to a request or can be determined on a periodic basis. The request may come from a user while the user is reviewing a loan application associated with a property or group of properties. The request can include identification information associated with the property or group of properties. In some embodiments, additional data may be provided by entities or users over network 24 that may also be considered by application 48 in the performance of the analytics. The determined analytics may be provided to a requesting entity/device or may be stored in a data repository

The risk detection applications 22 further include a “comparison” application or application component 50 (hereinafter “application 50”). As explained below application 50 can communicate with applications 42, 44, 46, and/or 48, to perform one or more comparisons between the results obtained from applications, 42, 44, 46, and/or 48.

### Natural Hazards Credit Risk Determination

Application 42 may be configured to determine default risks for real estate properties. U.S. Pat. Nos. 7,966,256 and 8,489,499, the contents of which are incorporated herein by reference in their entirety, disclose a process for determining a risk of default for real estate properties. For example, the process may predict the event of a 90 day delinquency anytime over the life of a loan associated with a real estate property. In one embodiment, as illustrated in FIG. 2, a model will be generated for the prediction of default based on loan data (e.g., loan purpose), borrower information (e.g., credit score, debt to income ratio, etc.), and property characteristics (e.g., loan to value ratio, combined loan to value ratio, etc.). Data repositories 30 and 32 may be accessed to determine the data used by the default risk prediction models. Traditional default prediction models do not consider the risks of default caused by natural hazards.

Application 44 may be configured to determine natural hazards risks for real estate properties. U.S. patent application Ser. No. 13/238,059, the contents of which are incorporated herein by reference in its entirety, disclose a process for determining a composite natural hazards risk for real estate properties. For example, the process may combine identified risks for natural hazards, such as flood, fire, earthquake, tornado, wind storm, hurricanes, storm surge, storm tide, lightning, thunder storm, hail, sinkholes, landslides, etc. to determine an overall composite natural hazards risk for a particular property of group of properties. Data repositories 32 and 34 may be accessed to determine the data used by the natural hazards risk prediction models. Traditional natural hazard risk models do not consider the risks of default caused by natural hazards.

Embodiments of the present invention, as illustrated in FIG. 2, generate a natural hazards credit risk model that creates a modified default risk model that also considers the risk of natural hazards. The inventors of the present application appreciate that the risks of natural hazards can affect the likelihood of default. The inventors understand that not only can natural hazards cause damage or loss to real estate properties, but they can impact the chance of a property owner going into default. The costs with dealing with natural hazards' effects may cause certain property owners to go into default or at least increase the chances of going into default. Insurance coverage, delays in receiving insurance payments, costs to rebuilding or fixing real estate properties may also impact default risks. As a result, embodiments of the present invention generate a combined natural hazards credit risk model that identifies the risk of default based at least in part on any identified natural hazards risks. Application 46 may be configured to determine natural hazards credit risks for real estate properties. As explained above, application 46 generates a combined natural hazards credit risk model based on the outputs from application 42 and 44. Optionally, in some embodiments, application 46 may access insurance database 36 to identify insurance coverage, costs of previous repairs/rebuilds from historical insurance data, efficiencies/delays associated with insurance companies of interest, etc. that may also be used by the natural hazards credit risk model.

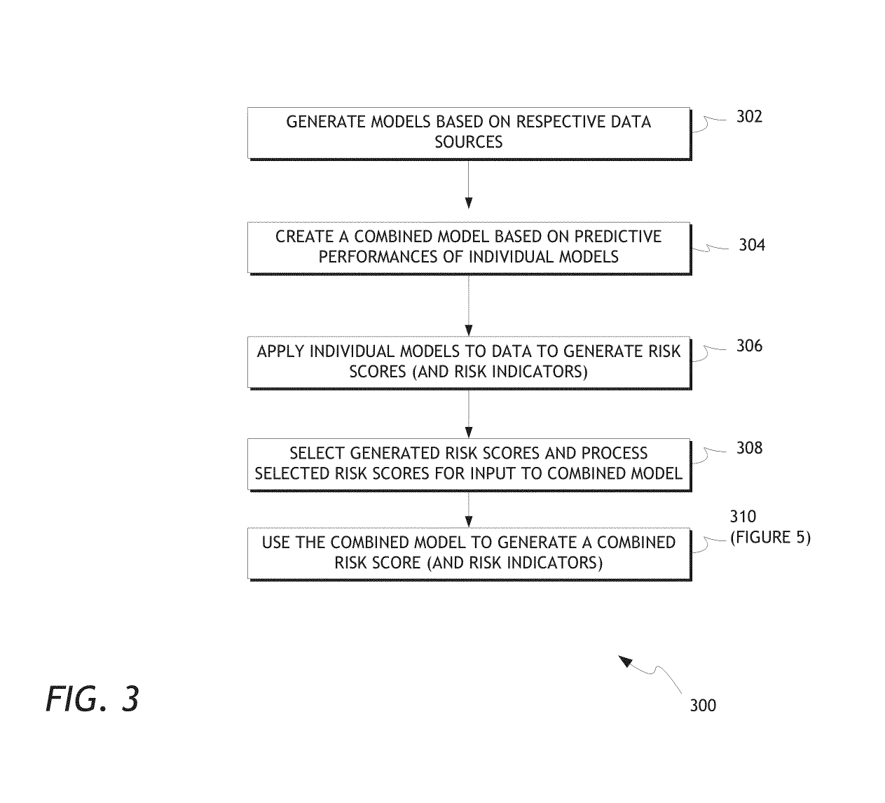

FIG. 3 is a flowchart illustrating a method of operation 300 of the risk detection system 20 to generate a natural hazards credit model to predict default risks based on natural hazards risks. In one embodiment, the method of operation 300 begins at a block 302 in which models (e.g., a default prediction model, a natural hazards risk model) are generated based on respective data sources. The models can also be generated by human programmers. In another embodiment, previously generated models from an external entity may be used.

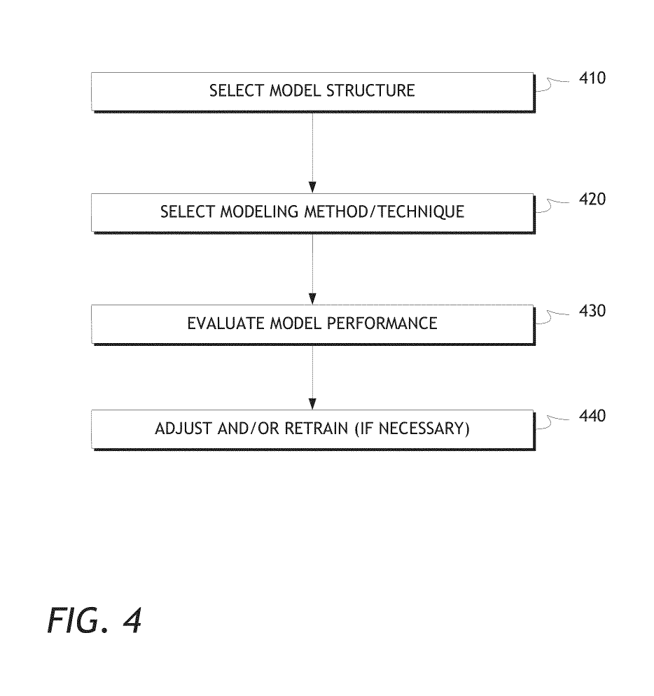

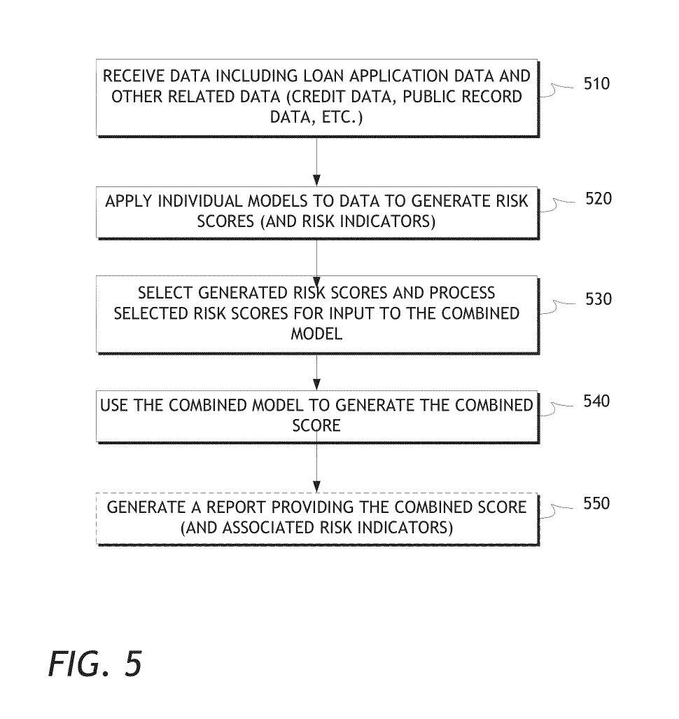

Next at a block 304, the risk detection system 20 creates one or more combined models based on the individual models. The one or more combined models combine the default risk and natural hazards models. As further described herein, the creation of the combined model may involve additional processing such as feature extraction. Further details on creating the combined model are provided with reference to FIGS. 4-5.

Proceeding to a block 306, the risk detection system 20 in one embodiment applies the individual models to data (including loan data and other non-loan data such as property data, borrower data, etc.) to generate risk scores. In a block 308, generated scores from the individual models are selected based on the combined model that is created and/or in use. In one embodiment, more than one combined model may be created and placed in use, and each combined model may select different generated scores from the individual models. In the block 308, the selected scores may also be processed, i.e., combined and/or mathematically manipulated into input features that will serve as input to the combined model in use. An example input feature may be the maximum of two or more model scores, e.g., max(model score 1, model score 2, . . . , model score n). Another example input feature may be the average of several model scores. In other embodiments, the input features may include other non-score data such as a loan amount and a combination of scores and non-score data. In one embodiment, the risk indicators from the block 306 are provided to the combined model as well.

Proceeding to a block 310, the risk detection system 20 in one embodiment uses the combined model to generate a combined risk score. Risk indicators may be provided by the combined model as well, based on the risk indicators generated in the block 306 by the individual models. The risk indicators enable the risk detection system 20 to output explanatory, i.e., textual information along with the combined risk score so a user can better understand the risk factors that contributed to the combined risk score and take appropriate remedial actions. For example, the natural hazards risk model may provide to the combined model a risk indicator indicating a high default risk due to property's fire risk. In the final combined risk score output, if the natural hazards risk model score is deemed to have contributed to the combined risk score in a significant way, the same risk indicator may be provided to the user so the user can investigate the property's fire risk. In one embodiment, the functions of blocks 306, 308, and 310 may be repeated for each loan application that is to be processed.

In one embodiment, risk detection system 20 generates and/or updates the combined models and their component models as new data is received or at specified intervals such as nightly or weekly. In other embodiments, some of models are updated continuously and others at specified intervals depending on factors such as system capacity, mortgage originator requirements or preferences, etc. In one embodiment, some models are updated periodically, e.g., nightly or weekly while other models are only updated when new versions of the risk detection system 20 are released into operation.

### Model Combination Process: Model Building

As illustrated in FIG. 4, generating the combined natural hazards risk model includes selecting modeling structure(s) (block 410) and modeling method(s)/technique(s) (block 420). In one embodiment, human analysts generate initial model structures and select the modeling methods used in the combined model. The combined model may be subsequently updated based on new or updated data (e.g., tagged historical data) to adapt the model to evolving risk trends.

The combined model may comprise any suitable structure of individual models. For example, the combined model may comprise model structures including one or more of a cascaded structure, a divide-and-conquer structure, and a mixed structure.

In a cascaded structure, scores of individual models are ranked in a specified order, e.g., model 1 . . . N. The first model score is initially joined with input fields to generate an intermediate stage 1 score; the second model score is again joined with the stage 1 score together with input fields to generate an intermediate stage 2 score; and so on. The last model score is joined with the stage N−1 score (or all the previous scores) together with input fields to generate the output of the overall combined model. In each cascaded stage, the tag information can be either the same for all the cascades or have different types of risk in cascades (if the target for each stage is the residue between the tag and the previous score starting from the second stage, it implements a boosting methodology).

In a divide-and-conquer structure, each individual model acts as an independent module and a combination gate incorporates all the model scores with the other interactive input fields to produce the final output score.

In a mixed structure, any module of cascaded or divide-and-conquer structures may be replaced by another network of further individual models. For example, in the cascaded structure, the last stage of the cascaded structure can be a divide-and-conquer structure. As a further example, in the divide-and-conquer structure, one or more of the modules can be replaced by a cascaded structure.

As noted above, FIG. 4 illustrates generating the combined natural hazards risk model includes selecting modeling structure(s) (block 410) and modeling method(s)/technique(s) (block 420). Once the structure of the combined model is selected at block 410, in one embodiment a suitable modeling technique/method is applied to generate each individual model at block 420. Such modeling techniques may include but are not limited to linear regression, logistic regression, neural networks, support vector machines, decision trees, and their derivatives. Suitable modeling methods may include machine learning/data mining techniques including linear regression, logistic regression, neural networks, support vector machine, decision tree, etc. In practice, one technique can be used in the research effort to provide insights for another modeling technique. Thus a combination of techniques can be used in the analysis and in the product implementation.

As discussed above, suitable modeling methods include linear regression and/or logistic regression. Linear regression is a widely used statistical method that can be used to predict a target variable using a linear combination of multiple input variables. Logistic regression is a generalized linear model applied to classification problems. It predicts log odds of a target event occurring using a linear combination of multiple input variables. These linear methods have the advantage of robustness and low computational complexity. These methods are also widely used to classify non-linear problems by encoding the nonlinearity into the input features. Although the mapping from the feature space to the output space is linear, the overall mapping from input variables through features to output is nonlinear and thus such techniques are able to classify the complex nonlinear boundaries. Desirably, the linear mapping between the feature space and the output space may make the final score easy to interpret for the end users.

Another suitable modeling method is neural networks. Logistic regression generally needs careful coding of feature values especially when complex nonlinear problems are involved. Such encoding needs good domain knowledge and in many cases involves trial-and-error efforts that could be time-consuming. A neural network has such nonlinearity classification/regression embedded in the network itself and can theoretically achieve universal approximation, meaning that it can classify any degree of complex problems if there is no limit on the size of the network. However, neural networks are more vulnerable to noise and it may be more difficult for the end users to interpret the results. In one embodiment, one suitable neural network structure is the feed-forward, back-prop, 1 hidden layer version. Neural networks may provide more robust models to be used in production environments when based on a larger data set than would be need to provide robust models from logistic regression. Also, the number of hidden nodes in the single hidden layer is important: too many nodes and the network will memorize the details of the specific training set and not be able to generalize to new data; too few nodes and the network will not be able to learn the training patterns very well and may not be able to perform adequately. Neural networks are often considered to be “black boxes” because of their intrinsic non-linearity. Hence, in embodiments where neural networks are used, when higher natural hazards credit risks are returned accompanying reasons are also provided. One such option is to provide natural hazards credit indicators in conjunction with scores generated by neural network based models, so that the end user can more fully understand the decisions behind the high natural hazards credit risks.

Embodiments may also include models that are based on support vector machines (SVMs). A SVM is a maximum margin classifier that involves solving a quadratic programming problem in the dual space. Since the margin is maximized, it will usually lead to low generalization error. One of the desirable features of SVMs is that such a model can cure the “curse of dimensionality” by implicit mapping of the input vectors into high-dimensional vectors through the use of kernel functions in the input space. A SVM can be a linear classifier to solve the nonlinear problem. Since all the nonlinear boundaries in the input space can be linear boundaries in the high-dimensional functional space, a linear classification in the functional space provides the nonlinear classification in the input space. It is to be recognized that such models may require very large volume of independent data when the input dimension is high.

Embodiments may also include models that are based on decision trees. Decision trees are generated using a machine learning algorithm that uses a tree-like graph to predict an outcome. Learning is accomplished by partitioning the source set into subsets using an attribute value in a recursive manner. This recursive partitioning is finished when pre-selected stopping criteria are met. A decision tree is initially designed to solve classification problems using categorical variables. It can also be extended to solve regression problem as well using regression trees. The Classification and Regression Tree (CART) methodology is one suitable approach to decision tree modeling. Depending on the tree structure, the compromise between granular classification, (which may have extremely good detection performance) and generalization, presents a challenge for the decision tree. Like logistic regression, results from decisions trees are easy to interpret for the end users.

Once the modeling method is determined, the natural hazards credit risk model is trained based on the historical data adaptively. The parameters of the model “learn” or automatically adjust to the behavioral patterns in the historical data and then generalize these patterns for detection purposes. When a new loan is scored, the risk detection system 20 will generate a combined score to evaluate its risk based on what it has learned in its training history. The modeling structure and modeling techniques for generating the combined model may be adjusted in the training process recursively.

The listing of modeling techniques provided herein are not exhaustive. Those skilled in the art will appreciate that other predictive modeling techniques may be used in various embodiments. Example predictive modeling techniques may include Genetic Algorithms, Hidden Markov Models, Self Organizing Maps, Dynamic Bayesian Networks, Fuzzy Logic, and Time Series Analysis. In addition, in one embodiment, a combination of the aforementioned modeling techniques and other suitable modeling techniques may be used in the natural hazards credit risk model.

As depicted in block 430 of FIG. 4, the performance of the natural hazards credit risk model may be evaluated in its predictive power and generalization prior to release to production. For example, in one embodiment the performance of a natural hazards credit risk model is evaluated on both the training dataset and the testing dataset, where the testing dataset is not used during the model development. The difference between the performance in the training data and the testing data demonstrates how robust the model is and how much the model is able to generalize to other datasets. The closer the two performances are, the more robust the model is.

Finally, at a block 440, the natural hazards credit risk model may be adjusted and/or retrained as needed. For example, the natural hazards credit risk model may be adjusted to use a different modeling technique, based on the evaluation of the model performance. The adjusted natural hazards credit risk model may then be re-trained. In another example, the natural hazards credit risk model may be re-trained using updated and/or expanded data (e.g., natural hazards data) as they become available.

The outputs of the natural hazards credit model may be collected by application 48 to identify any natural hazards credit risk trends (discussed below). The application 48 may collect natural hazards credit risk outputs from the generated natural hazards credit risk model at periodic intervals to identify natural hazards credit risk trends. The identified natural hazards credit risk outputs and/or trends may be stored or provided to interested parties, such as the computing device 26.

### Scoring Process Using the Combined Model

FIG. 5 is a flowchart illustrating an example of a method using the combined natural hazards credit model to generate a combined risk score as indicated in block 310 of FIG. 3. The method begins at a block 510 in which the system receives data from which a combined score is to be calculated, including data associated with a particular mortgage transaction for processing as well as other data external to the transaction such as borrower data, property record data, etc. The mortgage transaction data may comprise data of a mortgage application, an issued mortgage, or any other suitable loan or application. Data may be received from the loan database 30 and/or other data sources.

Next at a block 520, the risk detection system 20 applies the individual models to the received data to generate risk scores from the models. At a block 530, the generated scores are selected, depending on the combined model that is created or in use. In one embodiment, more than one combined model may be created, and each combined model may select a different mix of scores from the individual models. The selected scores and potentially other input data (e.g., a loan purpose) may also be processed, i.e., combined and/or mathematically manipulated into input features that will serve as input to the combined model that is in use. In some embodiments, insurance data may also be processed. At a block 540, the risk detection system 20 may use the combined model with the input features to generate the combined score. Moving to a block 550, the risk detection system 20 may optionally generate a report providing combined score and associated risk indicators. In one embodiment, the combined model may selectively output the risk indicators generated by the individual models, e.g., based on the weighting or a model result in the combined model. For example, risk indicators associated with selected individual model scores used are provided as output.

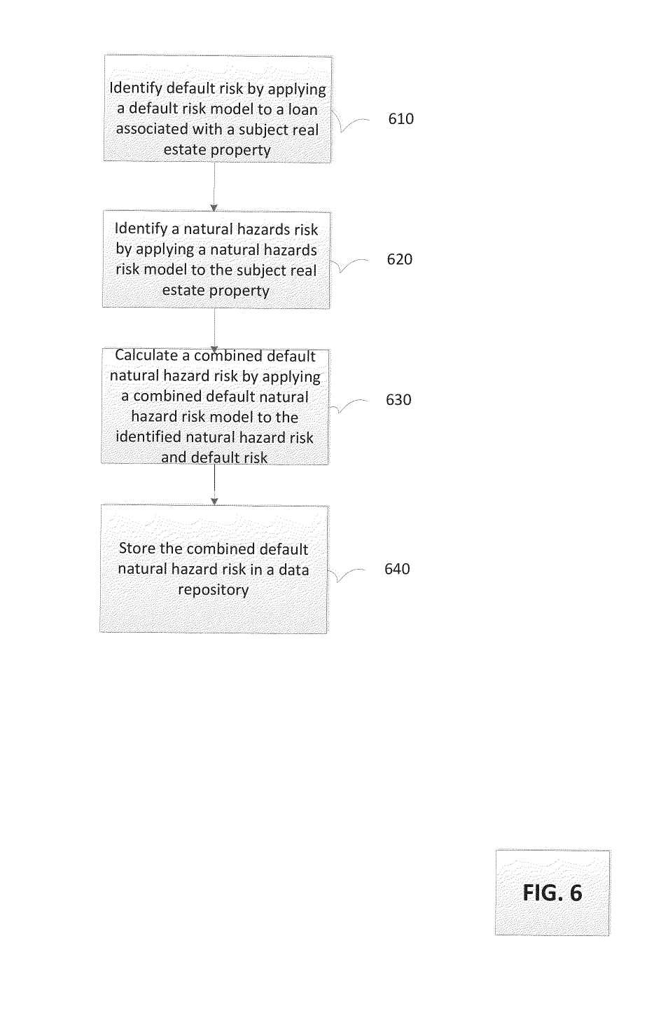

FIG. 6 is a flowchart illustrating a more detailed example of a method of generating a combined natural hazards credit score as indicated in block 310 of FIG. 3. The method begins at a block 610 in which the system identifies a default risk by applying a default risk model to a loan associated with a subject real estate property. As discussed above, the process may predict the event of a 90 day delinquency anytime over the life of the loan associated with the subject real estate property

Next at a block 620, the risk detection system 20 identifies a natural hazard risk by applying a natural hazards risk model to the subject real estate property. At a block 630, a combined default natural hazard risk is calculated by applying a combined default natural hazard risk model to the identified default and natural hazard risks. As discussed above, in one embodiment, more than one combined model may be created, and each combined model may select a different combination of scores from the default and natural hazard models. At a block 640, the risk detection system 20 may store the calculated combined natural hazard risk in a data repository. The stored calculated combined natural hazard risk can be used in a variety of applications and analytics (discussed below). As discussed above, the risk detection system 20 may optionally generate a report providing the combined score and associated risk indicators.

### Financial Characteristic Adjustment Using the Combined Model

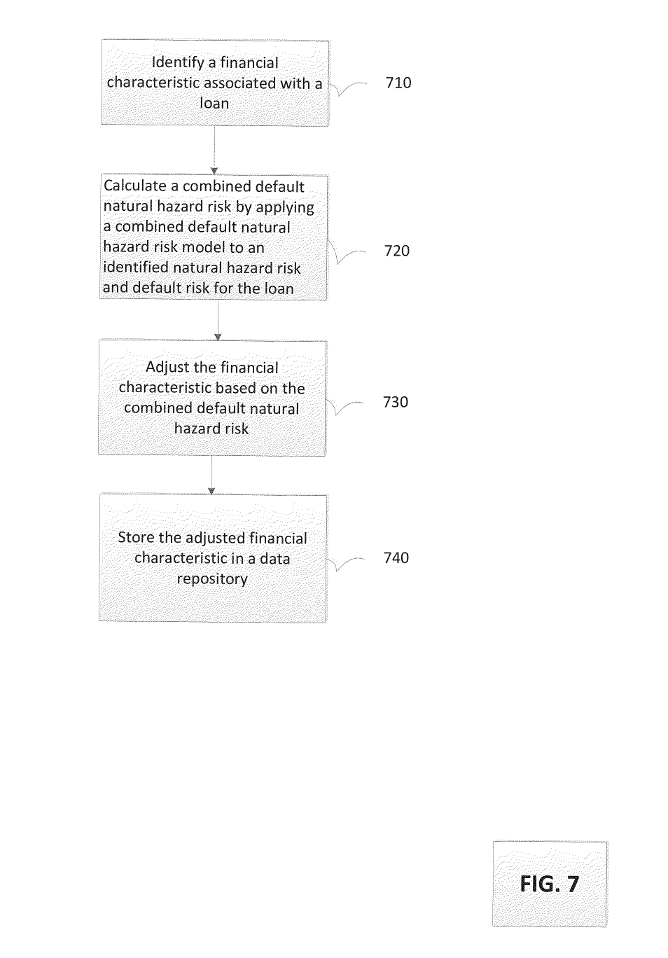

In some embodiment, the calculated combined default natural hazard risk can be used in a variety of applications. For example, since the combined default natural hazard risk may provide an enhanced risk picture for properties and loans, risk metrics, such as origination characteristics, borrower characteristics, physical location and valuation information, etc., associated with the loans may be adjusted in view of the combined default natural hazard risk. FIG. 7 is a flowchart illustrating an example of a method using the combined natural hazards credit risk to adjust a financial characteristic (e.g., LTV, CLTV, etc.). The method begins at a block 710 in which the risk detection system 20 identifies any financial characteristic associated with a loan. The financial characteristic may include loan-to-value ratio, combined loan-to-value ratio, home equity combined loan-to-value ratio, credit score, or the like.

Next at a block 720, a combined default natural hazard risk is calculated, as discussed above, by applying a combined default natural hazard risk model to identified default and natural hazard risks. At a block 730, the identified financial characteristic is adjusted based at least in part on the calculated combined default natural hazard risk. The financial characteristic may be adjusted in any desired way. For example, the value of the subject property of the loan based on the combined default natural hazard risk may be adjusted based on the combined default natural hazard risk (discussed further below). The adjusted value may then be used to adjust any identified financial characteristics. For example, the adjusted value may be used to calculate an adjusted LTV, CLTY, HCLTV, etc. At a block 740, the risk detection system 20 may store the adjusted financial characteristic in a data repository. The risk detection system 20 may optionally generate a report providing adjusted financial characteristic which can be provided to interested properties.

As an illustration, in one embodiment, the following linear logistic model may be used for the default model and the combined default natural hazard risk model:

$$logit ( ρ ) = ln ( \frac{ρ}{1 - ρ} ) = α + {β}^{′} x$$

Where ρ represents the probability of a delinquency event, α represents the intercept, β′ is a vector of regression coefficients and x is a vector of explanatory variables. The probability ρ can be calculated as:

$$ρ = \frac{exp ( α + {β}^{′} x )}{1 + exp ( α + {β}^{′} x )} ; or ρ = \frac{1}{1 + exp ( - α - {β}^{′} x )}$$

The default model, as stated above, can be a simple credit model that can use a variety of characteristics, such as loan purpose, FICO, Loan-to-Value (LTV), Debt-to-Income (DTI) and documentation. The default model may be represented as:

logit(ρ_{base})=α+β′x

The combined default natural hazard risk model can have the same specification as the default model with the addition of the natural hazard risks. This model can be represented as:

logit(ρₕ)=α+β′x+βₕxₕ,

where βₕ is the coefficient for the natural hazard risk and xₕ is the natural hazard risk score.

As discussed above, by taking the difference between the default model and the combined default natural hazard risk model, it is possible to identify how natural hazard risks impact the probability a borrower will become 90 days delinquent over the life of the loan. This may be determined by:

Natural Hazard Risk=logit(ρ_{base})−logit(ρₕ)

Further, as also discussed above, adjustments to the value of any given model parameter in the default model may be made to calculate what value that parameter would have to have in order to account for the natural hazard risk. For example, it may be possible to adjust the LTV such that, the default model with an adjusted LTV, results in:

Natural Hazard Risk=logit(ρ_{base})−logit(ρ_{base adj.})

In other words:

Hazard Risk=(α+β′x+βₗₜᵥLTV_{actual})−(α+β′x+βₗₜᵥLTV_{adj.}),

Where βₗₜᵥ is the LTV coefficient in the default model, LTV_{actual} is the actual LTV and LTV_{adj.} is the adjusted LTV. Hence, to determine what the LTV is once adjusted to account for the natural hazard risk, the following may be used:

$${LTV}_{adj} = \frac{{β}_{ltv} {LTV}_{actual} - Natural Hazard risk}{{β}_{ttv}}$$

### Natural Hazard Credit Analytics

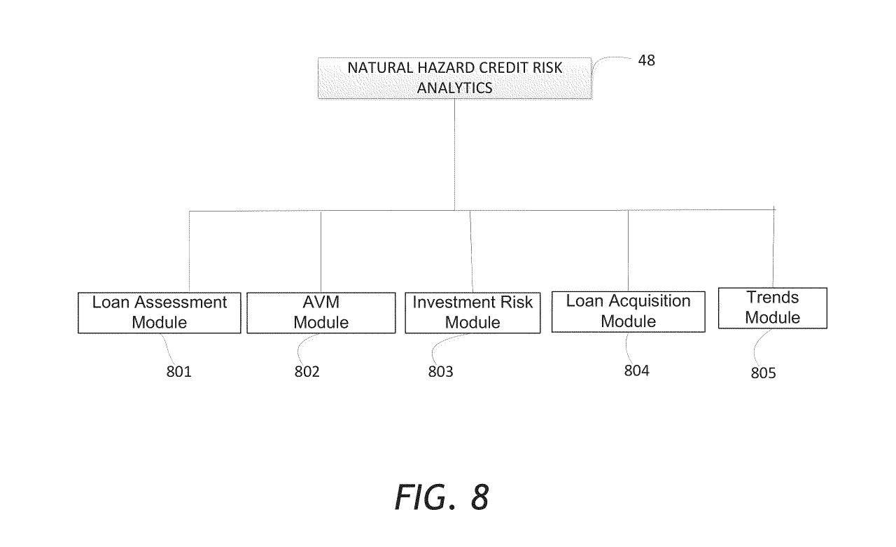

Application 48 may be configured to perform natural hazard credit analytics for a particular property or group of properties. In one embodiment, application 48 may be configured to implement one or more software modules to perform natural hazard credit analytics for a particular property or group of properties. For example, in some embodiments as shown in FIG. 8, the application 48 may be configured to implement a loan assessment module 801, an automated valuation module (AVM) module 802, an investment risk module 803, a loan acquisition module 804, and a trends module 805. Each of these example modules will be further explained below.

For example, in some embodiments, the loan assessment module 801 is configured to analyze loan applications based on the combined natural hazards credit model. In some embodiments, financial institutions, such as banks, lenders, etc. may provide underwriting rules to the risk detection provider. The underwriting rules may provide criteria for reviewing loans of customers. The financial institutions may also provide requests to have loan applications reviewed by the risk detection provider in view of the provided underwriting rules. The risk detection provider may analyze the loan applications in view of the underwriting rules and the calculated default natural hazard risk. The risk detection provider then may provide recommendations or risk indicators to the requesting financial institution. In various embodiments, the underwriting rules may be adjusted to account for the calculated natural hazard default risk and/or the calculated adjusted financial characteristics as discussed above. For example, if an underwriting rule includes a criterion that an LTV must not exceed a certain threshold in order to qualify for a loan, then risk detection system 20 may adjust the rule to use a different threshold based on the adjusted LTV values as discussed above. The value of the adjustment or threshold may be determined by analyzing historical loans from the loan database 30. The natural hazards credit model may be applied to the loans in loan database 30 to determine a threshold for which previous loans have been accepted/denied.

Next, in some embodiments, the AVM module 802 may be configured to communicate with application 48 to determine an automated valuation based at least in part on the calculated default natural hazard risk. An automated valuation model, such as a regression model, a neural network model, etc., may be generated using the calculated natural hazard default risk as an input along with any other desired inputs (e.g., property database 32) and an automated valuation as an output for the automated valuation model may be determined. For example, application 48 can communicate with AVM1 38A or AVM2 38B to determine an automated valuation for the particular property or group of properties. U.S. Pat. No. 5,361,201, which is hereby incorporated by reference in its entirety, describes various systems and methods for performing automated valuations of properties. Similarly, in some embodiments, an automated valuation for a property may be determined by the application of a valuation index, such as a Home Price Index (“HPI”) to historical prices and calculated default natural hazard risks associated with the property to determine the valuation of the property. In some embodiments, other types of valuations may be performed based on the calculated default natural hazard risks. For example, application 48 may provide the calculated default natural hazard risk for use in generation of an appraisal, a Broker Price Opinion (“BPO”), etc. In various embodiments, the automated valuation module may enable consumers to interactively communicate with the risk detection provider to determine what effect on an automated valuation for a property a particular natural hazard risk may have. For example, a user may request to receive information on the effect on the valuation of his/her property based on living in an area with a high fire hazard risk versus living in an area with less fire risk or an earthquake hazard risk. Application 48 can then request application 46 to calculate default natural hazard risks based on the user inputs and then provide automated valuations based on the calculated default natural hazard risks.

The investment risk module 803, may be configured to communicate with application 48 to determine an investment risk based at least in part on the calculated default natural hazard risk. In one embodiment an automated process may be used by the investment risk module 803 to identify an investment metric for real estate properties based in part on any natural hazard default risks for the real estate properties. For example, an investment score may be calculated based on any natural hazard credit risks. An investment score can provide a ranking that quantifies the investment risk in a property. However, one skilled in the art will realize that the investment score is representative, and similar metrics may also be calculated based in part on the identified default natural hazard risks. In this manner, investment metrics, including a risk score, early payment score, and the like may be calculated based in part on the identified default natural hazard risks. As mentioned above, this process may be useful (as one example) for enabling a lender to decide whether to provide a loan for a subject property.

The loan acquisition module 804 is configured to analyze loans for acquisitions based on the combined natural hazards credit model. For example, a financial institution in the secondary market may be interested in acquiring a portfolio of loans. Similar to the process discussed above with regards to the loan assessment module 801, financial institutions may provide one or more rules to the risk detection system 20 for consideration. The risk detection system 20 then may review loans in view of the provided rules and the calculated default natural hazard risks. Similar to the above, the risk detection system 20 then may provide recommendations and/or risk indicators to interest parties. The rules may also be adjusted based on the calculated default natural hazard risks as discussed above.

Next, in some embodiments, the trends module 805 may communicate with applications 46 and calculate a default natural hazard risk for one or more subject properties over a period of time to identify trends. The outputs of the natural hazards credit model may be collected and stored at a periodic frequency to identify trends in default natural hazard risks. For example, in some embodiments, default natural hazard risks found by the application 46 may be collected and stored every month to generate a default natural hazard risks trends table that can be stored or provided to interested parties such as the computing device 26. In some embodiments, the default natural hazard risks trends table may provide the identified default natural hazard risks in any format that is desired. For example, a default natural hazards risks table that provides an average default natural hazard risks amount by geographic area and year can be provided. Other dimensions could include percentage of change, natural hazard type, natural hazard frequency, etc. In various embodiments, default natural hazard risks trends may be provided as an index. The index can be used to show the collective level of natural hazard credit risks and trends in a dimension of interest. For instance, the index can represent the collective level (e.g., average, weighted average, etc.) of natural hazard credit risks in a particular zip code. As another example, the index could represent the collective level of fire default risks for three-bedroom houses in a particular zip code.

### Default Risks Comparison Using the Combined Model

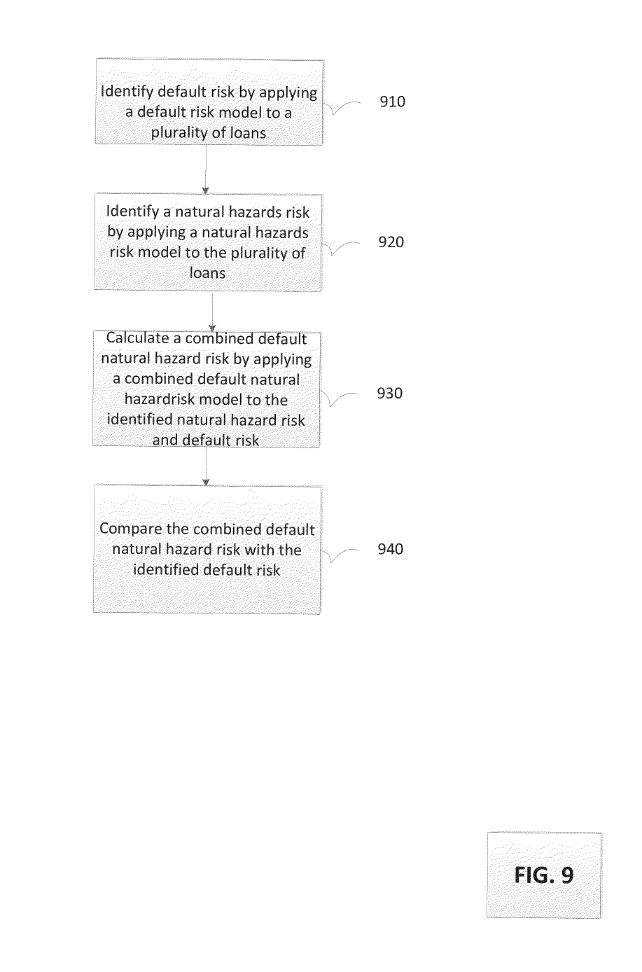

FIG. 9 is a flowchart illustrating an example of a method using the combined natural hazards credit model to provide a comparison of calculated default risks. The method begins at a block 910 in which the system identifies a default risk by applying a default risk model to a loan associated with a subject real estate property. As discussed above, the process may predict the event of a 90 day delinquency anytime over the life of the loan associated with the subject real estate property.

Next at a block 920, the risk detection system 20 identifies a natural hazard risk by applying a natural hazards risk model to the subject real estate property. At a block 930, a combined default natural hazard risk is calculated by applying a combined default natural hazard risk model to the identified default and natural hazard risks. As discussed above, in one embodiment, more than one combined model may be created, and each combined model may select a different combination of scores from the default and natural hazard models. At a block 940, the risk system 20 compares the calculated combined default natural hazard risk with the identified default risk. The default risk prior to application of the combined default natural hazard risk model is compared to combined default risk from applying the combined default natural hazard risk model. This comparison may enable the risk detection provider to provide information regarding the adjusted default risk caused by natural hazards. In some embodiments, a narrative around how much hidden default risk due to natural hazards exists in current default models may be created. For example, using an example default model, a fully documented loan with a credit score of 720, a debt-to-income ratio of 30 and an LTV of 75%, a probability of default of 11.88% may result. However, using the combined natural hazards credit model the same loan may have a probability of default from 8.23% with a natural hazard score of zero to 14.88% with a natural hazard score of 100. Now looking back at the original default model, in order to have a probability of default of 8.28% or 14.88%, the LTV may have to be adjusted to 29 and 101, respectively. That is, in the default model, the average loan with an LTV of 75 can behave like a loan with a LTV of 29 or an LTV of 101 depending on its location and natural hazard risk. This example illustrates how a natural hazard risk may impact LTV calculations and how LTV may be adjusted based on the combined risk calculations (discussed above). This comparison or narrative may be provided to interested parties as marketing information to enable the interested parties to understand potential limits on current default models that do not consider natural hazard risks. Risk detection system 20 may store the comparison and/or narrative in a data repository. As discussed above, the risk detection system 20 may optionally generate a report providing the comparison and/or narrative in any desired format.

Scoring Process after Occurrence of a Natural Hazard

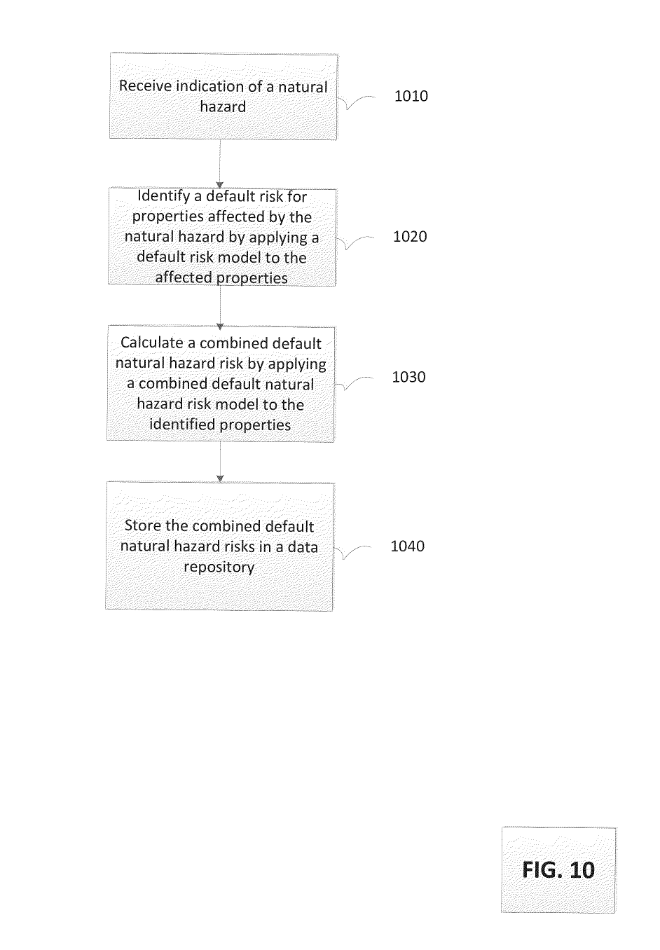

FIG. 10 is a flowchart illustrating an example of a method using the combined natural hazards credit model to provide a combined default natural hazard risk after an occurrence of a natural hazard. Embodiments of the present invention are not limited to calculation of default natural hazard risks prior to occurrence of natural hazards and where predictions of natural hazard risks are used in the combined model. After the occurrence of a natural hazard, the probability of the natural hazard is definite (e.g., 100%) and can be used to calculate the combined default natural hazard risk. The method begins at a block 1010 in which the system receives identification of a natural hazard. The risk detection entity can receive the identification of the natural hazard from third-parties, such as government agencies, Weather Services International, National Weather Service, Weather Channel Company, etc. Risk detection system 20 may receive alerts from these third-parties or may access electronic data resources from these third-parties to receive identification information of natural hazard.

Next at a block 1020, the risk detection system 20 identifies default risk by applying a default model to the real estate properties affected by the identified natural hazard. The impact of the natural hazard is determined and properties affected by the natural hazard are identified. The properties may be provided by the third-parties discussed above or by any other entities. Subsequently, a default model, as discussed above, may be applied to each of the identified properties to determine a respective default risk associated with the identified properties. At a block 1030, a combined default natural hazard risk is calculated by applying a combined default natural hazard risk model to the identified properties. The combined default natural hazard risk model may be applied based on the calculated default risks from block 1020 and the occurrence of the natural hazard. For the occurrence of the natural hazard, the type, severity, damage, etc. of the natural hazard for each of the identified properties may be identified for use in the combined default natural hazard risk model. In some embodiments, potentially other input data (e.g., a loan purpose, insurance data, etc.) may also be processed, i.e., combined and/or mathematically manipulated into input features that will serve as input to the combined model that is in use. At a block 1040, the risk detection system 20 may store the combined default natural hazard risk in a data repository. The risk detection system 20 may optionally generate a report providing the combined default natural hazard risk which can be provided to interested properties.

### CONCLUSION

All of the methods and tasks described herein may be performed and fully automated by a computer system. The computer system may, in some cases, include multiple distinct computers or computing devices (e.g., physical servers, workstations, storage arrays, etc.) that communicate and interoperate over a network to perform the described functions. Each such computing device typically includes a processor (or multiple processors) that executes program instructions or modules stored in a memory or other non-transitory computer-readable storage medium or device. The various functions disclosed herein may be embodied in such program instructions, although some or all of the disclosed functions may alternatively be implemented in application-specific circuitry (e.g., ASICs or FPGAs) of the computer system. Where the computer system includes multiple computing devices, these devices may, but need not, be co-located, and may be cloud-based devices that are assigned dynamically to particular tasks. The results of the disclosed methods and tasks may be persistently stored by transforming physical storage devices, such as solid state memory chips and/or magnetic disks, into a different state.

The methods, processes and applications described above may be embodied in, and fully automated via, software code modules executed by one or more general purpose computers. The code modules, such as the default determination module 42, natural hazard determination module 44, natural hazards credit determination module 46, analytics module 48, and comparison module 50, may be stored in any type of computer-readable medium or other computer storage device. Some or all of the methods may alternatively be embodied in specialized computer hardware. Code modules or any type of data may be stored on any type of non-transitory computer-readable medium, such as physical computer storage including hard drives, solid state memory, random access memory (RAM), read only memory (ROM), optical disc, volatile or non-volatile storage, combinations of the same and/or the like. The methods and modules (or data) may also be transmitted as generated data signals (e.g., as part of a carrier wave or other analog or digital propagated signal) on a variety of computer-readable transmission mediums, including wireless-based and wired/cable-based mediums, and may take a variety of forms (e.g., as part of a single or multiplexed analog signal, or as multiple discrete digital packets or frames). The results of the disclosed methods may be stored in any type of non-transitory computer data repository, such as databases 30-36, relational databases and flat file systems that use magnetic disk storage and/or solid state RAM. Some or all of the components shown in FIG. 1, such as those that are part of the risk detection system 20, may be implemented in a cloud computing system.

Further, certain implementations of the functionality of the present disclosure are sufficiently mathematically, computationally, or technically complex that application-specific hardware or one or more physical computing devices (utilizing appropriate executable instructions) may be necessary to perform the functionality, for example, due to the volume or complexity of the calculations involved or to provide results substantially in real-time.

Any processes, blocks, states, steps, or functionalities in flow diagrams described herein and/or depicted in the attached figures should be understood as potentially representing code modules, segments, or portions of code which include one or more executable instructions for implementing specific functions (e.g., logical or arithmetical) or steps in the process. The various processes, blocks, states, steps, or functionalities can be combined, rearranged, added to, deleted from, modified, or otherwise changed from the illustrative examples provided herein. In some embodiments, additional or different computing systems or code modules may perform some or all of the functionalities described herein. The methods and processes described herein are also not limited to any particular sequence, and the blocks, steps, or states relating thereto can be performed in other sequences that are appropriate, for example, in serial, in parallel, or in some other manner. Tasks or events may be added to or removed from the disclosed example embodiments. Moreover, the separation of various system components in the implementations described herein is for illustrative purposes and should not be understood as requiring such separation in all implementations. It should be understood that the described program components, methods, and systems can generally be integrated together in a single computer product or packaged into multiple computer products. Many implementation variations are possible.

The processes, methods, and systems may be implemented in a network (or distributed) computing environment. Network environments include enterprise-wide computer networks, intranets, local area networks (LAN), wide area networks (WAN), personal area networks (PAN), cloud computing networks, crowd-sourced computing networks, the Internet, and the World Wide Web. The network may be a wired or a wireless network or any other type of communication network.

The various elements, features and processes described herein may be used independently of one another, or may be combined in various ways. All possible combinations and subcombinations are intended to fall within the scope of this disclosure. Further, nothing in the foregoing description is intended to imply that any particular feature, element, component, characteristic, step, module, method, process, task, or block is necessary or indispensable. The example systems and components described herein may be configured differently than described. For example, elements or components may be added to, removed from, or rearranged compared to the disclosed examples.

As used herein any reference to “one embodiment” or “some embodiments” or “an embodiment” means that a particular element, feature, structure, or characteristic described in connection with the embodiment is included in at least one embodiment. The appearances of the phrase “in one embodiment” in various places in the specification are not necessarily all referring to the same embodiment. Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. In addition, the articles “a” and “an” as used in this application and the appended claims are to be construed to mean “one or more” or “at least one” unless specified otherwise.

As used herein, the terms “comprises,” “comprising,” “includes,” “including,” “has,” “having” or any other variation thereof, are open-ended terms and intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or”. For example, a condition A or B is satisfied by any one of the following: A is true (or present) and B is false (or not present), A is false (or not present) and B is true (or present), and both A and B are true (or present). As used herein, a phrase referring to “at least one of” a list of items refers to any combination of those items, including single members. As an example, “at least one of: A, B, or C” is intended to cover: A, B, C, A and B, A and C, B and C, and A, B, and C. Conjunctive language such as the phrase “at least one of X, Y, and Z,” unless specifically stated otherwise, is otherwise understood with the context as used in general to convey that an item, term, etc. may be at least one of X, Y, or Z. Thus, such conjunctive language is not generally intended to imply that certain embodiments require at least one of X, at least one of Y, and at least one of Z to each be present.

The foregoing disclosure, for purpose of explanation, has been described with reference to specific embodiments, applications, and use cases. However, the illustrative discussions herein are not intended to be exhaustive or to limit the inventions to the precise forms disclosed. Many modifications and variations are possible in view of the above teachings. The embodiments were chosen and described in order to explain the principles of the inventions and their practical applications, to thereby enable others skilled in the art to utilize the inventions and various embodiments with various modifications as are suited to the particular use contemplated.

What is claimed is:

1. A system for detecting and assessing lending risks, the system comprising:
a computer system comprising one or more computing devices, the computer system programmed, via executable code modules, to implement:
a combined risk detection model for detecting and assessing data indicative of a plurality of risks in loan data, the combined risk detection model adapted to receive as input a plurality of input features extracted from two or more of a plurality of risk detection models, the plurality of risk detection models comprising:
a default risk model that detects the presence of data indicative of a risk of early payment default in the loan data, and
a natural hazard risk model that detects the presence of data indicative of a risk of a natural hazard in the loan data,
wherein the plurality of input features are extracted from the two or more risk detection models by mathematically combining scores from the plurality of risk detection models for input into the combined risk detection model, the plurality of input features being selected as based at least in part on a selection of a modeling method used to construct the combined risk detection model; and
a score reporting module that reports a composite risk score generated by the combined risk detection model.

2. The system of claim 1, wherein the score reporting module further reports a plurality of risk indicators generated by the plurality of risk detection models.

3. The system of claim 2, wherein each of the risk indicators references the natural hazard risk and is classified in accordance with a weight contribution of the referenced natural hazard risk to the composite risk score.

4. The system of claim 3, wherein each of the risk indicators is classified as a high risk, a moderate risk, or a low risk based on the weight contribution of the referenced natural hazard risk.

5. The system of claim 1, wherein the combined risk detection model comprises one or more of the following modeling methods: linear regression, logistic regression, neural networks, support vector machines, and decision trees.

6. The system of claim 5, wherein the combined risk detection model comprises one or more of the following modeling structures:
a cascade structure; and a divide-and-conquer structure.

7. The system of claim 1, wherein the composite risk score is used to adjust a numerical indicator associated with the loan data.

8. The system of claim 7, wherein the numerical indicator comprises an LTV ratio.

9. The system of claim 7, wherein the numerical indicator comprises a CLTV ratio.

10. The system of claim 1, wherein the composite risk score is compared to the detected default risk.

11. The system of claim 10, wherein the comparison is provided in a report as a narrative.

12. The system of claim 1, wherein the composite risk score is used to calculate an automated valuation for a real estate property associated with the loan data.

13. The system of claim 1, wherein the score reporting module further reports a recommendation for processing the loan data based at least in part on the composite risk score.

14. The system of claim 1, wherein the loan data is associated with a loan being sold in a secondary market.

15. The system of claim 1, wherein the loan data is associated with a pending loan application.

16. The system of claim 1, wherein the plurality of input features further comprise insurance data.

17. A system comprising:
physical data storage configured to store loan data; and
a computer system in communication with the physical data storage, the computer system comprising computer hardware, the computer system programmed to:
identify a default risk associated with the loan data, the default risk identified by application of a default risk model that detects the presence of data indicative of a risk of early payment default in the loan data;
identify a natural hazard risk associated with the loan data, the natural risk identified by application of a natural risk model that detects the presence of data indicative of a risk of a natural hazard in the loan data;
calculate a combined default natural hazard risk, the combined default natural hazard risk calculated by application of a combined risk detection model to the identified default risk and the identified natural hazard risk
adjust a financial characteristic associated with the loan data based at least in part on the calculated combined default natural hazard risk; and
store the adjusted financial characteristic in the physical data storage.

18. The system of claim 17, wherein the financial characteristic comprises an LTV ratio.

19. The system of claim 17, wherein the financial characteristic comprises a CLTV ratio.

20. A system comprising:
physical data storage configured to store loan data; and
a computer system in communication with the physical data storage, the computer system comprising computer hardware, the computer system programmed to:
identify a default risk associated with the loan data, the default risk identified by application of a default risk model that detects the presence of data indicative of a risk of early payment default in the loan data;
identify a natural hazard risk associated with the loan data, the natural risk identified by application of a natural risk model that detects the presence of data indicative of a risk of a natural hazard in the loan data;
calculate a combined default natural hazard risk, the combined default natural hazard risk calculated by application of a combined risk detection model to the identified default risk and the identified natural hazard risk;
compare the calculated combined default natural hazard risk with the identified default risk; and
store the comparison in the physical data storage.
